(19) United States
(12) Patent Application Publication
(10) Pub. No.: US 2024/0047120 A1
(43) Pub. Date: Feb. 8, 2024

(54) BALANCED BOOST DC/DC CONVERTER

(71) Applicant: ZF Friedrichshafen AG, Friedrichshafen (DE)

(72) Inventors: Manuel Raimann, Salem (DE); Pengshuai Wang, Eriskirch (DE)

(73) Assignee: ZF Friedrichshafen AG, Friedrichshafen (DE)

(21) Appl. No.: 18/364,937

(22) Filed: Aug. 3, 2023

(30) Foreign Application Priority Data
Aug. 3, 2022 (DE) 102022208008.4

(51) Int. Cl. H01F 27/28; H02M 3/158; H01F 27/24; B60L 50/70

(52) U.S. Cl. CPC H01F 27/2823; H02M 3/158; H01F 27/24; B60L 50/70; B60L 2210/14

(57) ABSTRACT

A symmetrical DC-to-DC boost converter includes two magnetically coupled chokes, of which one choke is connected to a negative DC voltage input in the DC-to-DC boost converter, while the other choke is connected to a positive DC voltage input in the DC-to-DC boost converter, such that a symmetrical topology is obtained with separate DC voltage inputs, wherein the coupled chokes have three cores in a series, each of which is connected at the top and bottom to a connecting core, and there is at least one winding on each of the two outer cores that is dedicated to one of the chokes, while the middle core does not have a winding, and has at least one air gap and/or is at least partially made of a low permeability powdered material, and therefore forms a magnetic energy storage.

### CROSS-REFERENCE TO RELATED APPLICATION

This application claims priority to German Application No. DE 10 2022 208 008.4, filed on Aug. 3, 2022, the entirety of which is hereby fully incorporated by reference herein.

### FIELD

The present invention relates to the field of electric vehicles, in particular DC-to-DC boost converters for an electric motor in a motor vehicle powered by fuel cells.

### BACKGROUND AND SUMMARY

Electronic modules such as power electronics modules have been used to an increasing extent in motor vehicles in the last decades. This is partially due to the necessity of conserving fuels and improving vehicle performance, as well as to the progress made in semiconductor technologies.

A DC-to-DC boost converter is used to create a high voltage internal electrical system and thus provide electricity to an electric motor from a fuel cell. This increases the voltage from the fuel cell to a predefined extent, and then supplies this voltage to the high voltage internal electrical system. There is a direct connection between the terminals in the fuel cells and the high voltage internal electrical system when using the DC-to-DC boost converters, resulting in an undesired asymmetry in the isolated voltages to the vehicle chassis. For this reason, the use of a symmetrical DC-to-DC boost converter with separate or magnetically coupled chokes has been proposed. The aim is to minimize ripple voltage in the choke and the associated core and winding losses.

The fundamental object of the invention is to therefore create a DC-to-DC boost converter that has magnetically coupled chokes with which ripple voltage can be minimized.

This problem is solved by the features in the independent claims. Advantageous embodiments are the subject matter of the dependent claims.

A symmetrical DC-to-DC boost converter is proposed that has two magnetically coupled chokes, one of which is connected to a negative DC voltage input in the DC-to-DC boost converter, while the other is connected to a positive DC-to-DC voltage input, such that a symmetrical topology with separate DC voltage inputs is obtained in which the coupled chokes have three cores connected in series and connecting cores connected to their upper and lower ends, and there is at least one winding on each of the two outer cores that is dedicated to one of the chokes, while the middle core does not have a winding, and has at least one air gap and/or is made at least in part of a low permeability powdered material, thus functioning as a magnetic power storage.

In one embodiment, the air gap is formed by either a single air gap or multiple air gaps.

In one embodiment, the middle core has three air gaps.

In one embodiment, at least the outer cores are made of a high permeability ferrite.

In one embodiment, the windings are HF braids or Cu flat wire windings, or round Cu windings.

In one embodiment, the symmetrical DC-to-DC boost converter has a cooling system for cooling the chokes, wherein the cooling system has a heat sink with a housing, which has a surface, the shape of which corresponds to at least one of the chokes such that a gap is formed between the surface and the winding that is filled with a thermally conductive material.

In one embodiment, the housing is filled with a thermally conductive potting material.

In one embodiment, the two outer cores have a minimal air gap.

Use of the DC-to-DC boost converter is also proposed for a motor vehicle powered by a fuel cell.

A fuel cell drive for a motor vehicle is also proposed, which has a fuel cell and the DC-to-DC boost converter, in which the DC voltage inputs in the DC-to-DC boost converter are connected to the fuel cell, and the DC voltage outputs are connected to a high voltage internal electrical system in the motor vehicle, which has an electric motor, as DC voltage inputs.

A motor vehicle is also proposed, which has an electric motor powered by the fuel cell drive.

Further features and advantages of the invention can be derived from the following description of exemplary embodiments of the invention based on the drawings showing details of the invention, and the claims. The individual features can be obtained in and of themselves or in arbitrary combinations in various versions of the invention.

Preferred embodiments of the invention shall be explained in greater detail below in reference to the drawings.

### BRIEF DESCRIPTION OF THE DRAWINGS

FIG. 1 shows a fundamental assembly of magnetically coupled chokes for use in a DC-to-DC boost converter according to one embodiment of the present invention;

FIG. 2 shows the assembly shown in FIG. 1, without windings;

FIG. 3 shows a sectional view of the DC-to-DC boost converter shown in FIG. 1, with a cooling system according to an embodiment of the present invention;

FIG. 4 shows a magnetic equivalent circuit diagram (permeance circuit diagram) of the magnetically coupled chokes according to an embodiment of the present invention; and

FIG. 5 shows a switch assembly for a DC-to-DC boost converter with magnetically coupled chokes according to an embodiment of the invention.

### DETAILED DESCRIPTION

Identical elements and functions have the same reference symbols in the following descriptions of the drawings.

DC-to-DC boost converters are also referred to as step-up or simply boost converters. The output voltage in these converters is always higher than the input voltage. DC-to-DC boost converters can therefore be used in the field of drive engineering for motor vehicles. In particular, they can be used in the framework of a drive obtained with fuel cells. The DC-to-DC boost converter in this case converts an input voltage of e.g. 400V from the fuel cell into an output voltage of, e.g. 800V for the high voltage internal electrical system (HV internal electrical system) connected to the DC-to-DC boost converter, i.e. the drive in the form of an electric motor.

The fundamental assembly of DC-to-DC boost converters is known and shall not be repeated here. Because the DC-to-DC boost converter must provide all of the power for the drive, a galvanic separation is not advantageous. This is why a symmetrical DC-to-DC boost converter topology with separate negative and positive DC voltage inputs is used. This symmetrical DC-to-DC boost converter topology results in a symmetrical division of the DC-to-DC boost converter input voltage. This also results in a symmetrical division of the input voltage in the HV internal electrical system, which corresponds to the output voltage of the DC-to-DC boost converter. With this symmetrical multi-level DC-to-DC boost converter, there are two magnetically coupled (sub)-chokes 105, 106 that have dedicated windings 10, 11, with which a symmetrical division of the input voltage in the DC-to-DC boost converter can be obtained.

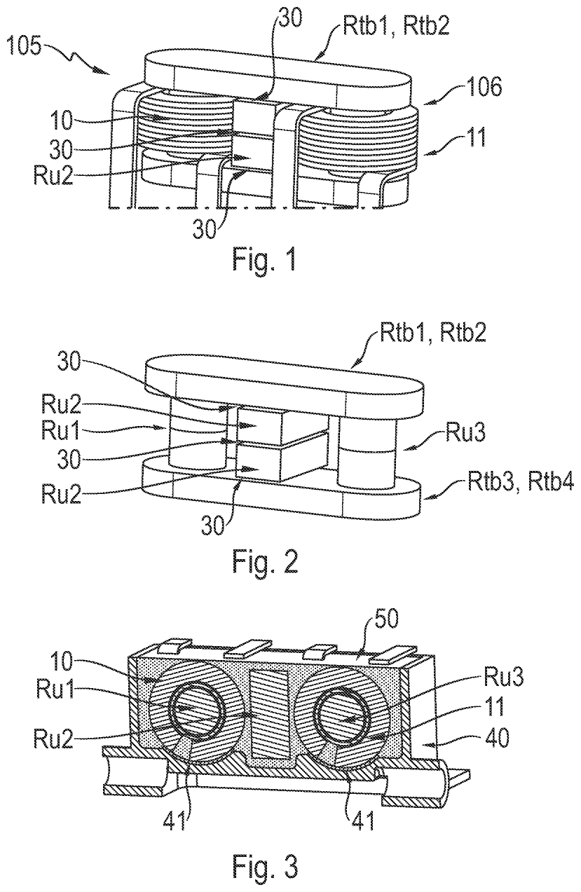

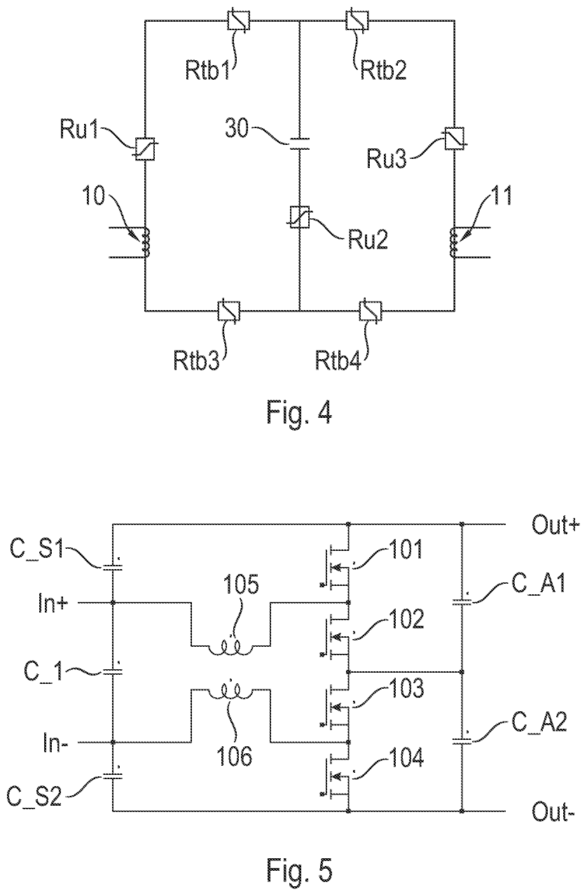

The core idea of the invention is to create a magnetically coupled chokes 105, 106 with which ripple voltages and their associated core and winding losses can be minimized through a magnetic coupling of the two windings 10, 11 (also referred to as sub-windings) in the (sub)-chokes 105, 106. Before explaining the magnetic equivalent circuit diagram shown in FIG. 4, the fundamental assembly of the coupled chokes 105, 106 shall be explained in reference to FIGS. 1 to 3.

FIGS. 1 and 2 show a choke 105, 106 that has a core formed by numerous sub-cores RU1-3, Rtb1-4 (referred to below as cores Ru1-3 and connecting cores Rtb1-4). This choke contains three adjacent and parallel cores Ru1-3 and two connecting cores or core covers Rtb1-2 (on top) and Rtb3-4 (on the bottom) above and below the cores Ru1-3 (as can be seen clearly in FIG. 2), resulting in a closed magnetic circuit. the core covers Rtb1-4 thus connect the cores Ru1 and Ru3 to one another to obtain the magnetic coupling. They are advantageously made of the same material as the outer cores Ru1 and Ru3, e.g. a magnetically conductive material such as a high permeability ferrite. They can also be composed of multiple parts.

The windings 10, 11 of the chokes 105, 106 are also placed on the two outer cores Ru1, Ru3 (as shown in FIG. 1).

In the embodiment shown in FIG. 1, all three cores Ru1-3 have a triple air gap 30, in which the air gaps 30 in the middle core Ru2 are significantly larger than the air gaps in the outer cores Ru1, Ru3, due to the production process. The air gaps in the outer cores Ru1, Ru3 are ideally as small as possible. The cores Ru1-3 are also made of a high permeability ferrite. Multiple air gaps 30 reduce winding losses, because there is less leakage. The air gaps 30 can form actual gaps in the material forming the cores Ru1-3. One of the cores Ru1-3, preferably the middle core Ru2, can also be made of a low permeability powdered material or a combination of a low permeability powdered material and a ferrite.

The windings 10, 11 are made of a Cu (copper) flat wire in the embodiment shown in FIG. 1. They can also be made of an HF (high frequency) braid or a round Cu winding.

There can also be more than two windings 10, 11, resulting in a coupling with more than two phases (N>2).

FIG. 3 shows the thermal connection of the chokes 105, 106 to a cooling system, specifically to the housing 40 for a heat sink. The heat sink discharges heat generated by the core and winding losses. They are therefore connected to the housing which can be made of aluminum, for example. The housing 40 fits onto at least one of the windings 10, 11. This means that the shape of the surface corresponds to the shape of the winding 10, 11. FIG. 3 shows that the shape of the housing 40 where it is connected to the windings 10, 11 is curved to fit the shape of the windings 10, 11.

A very small gap 41 is formed between the windings 10, 11 and the housing A thermally conductive material, e.g. a gap pad, is placed in this gap 41 to further improve the heat removal. The closer the housing 40 and windings 10, 11 are to one another, the better the heat discharge. In this regard, other surfaces of the housing 40 can also correspond to the shape of the windings 10, 11.

The empty spaces inside the housing 40 are advantageously filled with a thermally conductive potting material. This improves heat discharge (because air is a poor thermal conductor), and also helps to the mechanically secure the coupled chokes 105, 106 in place.

The coupled chokes 105, 16 are fundamentally structured such that the two outer cores Ru1, Ru3 form a magnetic coupling with the connecting cores Rtb1-4. The middle core Ru2 forms a magnetic energy storage. This energy is stored in the at least one air gap 30 or the low permeability powdered material.

The magnetic equivalent circuit diagram (permeance circuit diagram) shown in FIG. 4 shall be explained in greater detail below.

The windings 10, 11 on the outer cores Ru1, Ru3, which are connected to the rest of the circuit (see FIG. 5), are shown on the right and left sides of the circuit. The magnetic coupling and the energy storage shall be explained below.

The cores Ru1, Rtb1-2, Ru3, and Rtb4-3 for a closed magnetic circuit. They form the magnetic coupling between the two windings 10, 11, because their magnetically conductive material exhibits a very low magnetic resistance. They ensure the desired reduction in the ripple voltage.

Another closed magnetic circuit is also formed by the cores Ru1-Ru3 with the optional air gap 3, because a part of the magnetic field flowing through the cores Ru1, Rtb1-2, Ru3 and Rtb4-3 is conducted through the middle core Ru2. This magnetic circuit is used for storing energy (through the air gap 30 or the low permeability powdered material of the core Ru2).

The proposed coupled chokes 105, 106 are advantageously used in a symmetrical DC-to-DC boost converter, as shown in FIG. 5. This preferably acts as a DC-to-DC boost converter for use in vehicle powered by fuel cells.

A circuit assembly for a symmetrical DC-to-DC boost converter shown in FIG. 5 contains numerous switches 101-104, which can be semiconductor switches, for example, forming half bridges (switches 101, 102 and switches 103, 104). A (sub)-choke 105 is electrically connected at one end to the positive DC voltage input In+. It is connected between the two adjacent switches 101, 102 in the middle at the other end. The two other ends of the switches 101, 102, i.e. the ends not connected to the choke 105, are connected to the negative and positive DC voltage outputs Out−, Out+. This assembly is mirrored for the negative DC voltage input In−, to obtain a symmetrical assembly. This means that the (sub)-choke 106 is electrically connected at one end to the negative DC voltage input In−, and the two other adjacent switches 103, 104 in the middle between at the other end. At least four switches 101-104 are advantageously connected in a series to the chokes 105, 106, such that there are at least three topological levels. There can also be more topological levels, which are then obtained with more than four switches 101-104. To obtain symmetry, the two adjacent switches are connected to the choke 105 and therefore the positive DC voltage input In+, and the other two adjacent switches are connected to the other choke 106, and therefore to the negative DC voltage input In−. This means that there can be two separate intermediate circuits in the HV internal electrical system, each of which is controlled by two switches 101, 102 or 103, 104, stacked on top of one another. There are output capacitors C_A1, C_A2 connected in series between the switches 101, 102 or 103, 104, and the negative or positive DC voltage outputs Out−, Out+, each of which forms an individual capacitor. There is a voltage pickup between each pair of switches 101, 102 and 103, 104, which are dedicated to the two coils 105 and 106, respectively, and thus to separate DC voltage inputs, which in turn is interconnected between the output capacitors C_A1, C_A2. The respective ends of the output capacitors C_A1, C_A2 are connected to the negative and positive DC voltage outputs Out−, Out+ respectively.

Three capacitors C_1, C_S1, C_S2, are connected in series at the inputs for the coils 105, 106 where they are electrically connected to the energy source, i.e. the fuel cell. The input capacitor C_1 is connected at an output to the positive DC voltage input In+ and to the negative DC voltage input In− at the other end. The symmetry capacitor C_S1 dedicated to the positive DC voltage input In+ is also connected at one end to the positive DC voltage input In+. It is connected at its other end to the positive DC voltage output Out+. The symmetry capacitor C_S2 dedicated to the negative DC voltage input In− is also connected at one end to the negative DC voltage input In−. It is connected to the negative DC voltage output Out− at the other end. The input capacitor C_1 prevents a jumping of the potential between the DC voltage inputs In−, In+. The two symmetry capacitors C_S1 and C_S2 prevent potential jumping between the positive DC voltage input In+ and the significantly higher potential at the positive DC voltage output Out+, and between the negative DC voltage input In− and the significantly higher potential at the negative DC output Out−.

An electronic module is used to operate an electric motor in a motor vehicle powered by a fuel cell in the framework of this invention. The motor vehicle is a commercial vehicle in particular, e.g. a truck or bus, or a passenger automobile. The power electronics module comprises a DC/AC inverter. It can also comprise an AC/DC rectifier, DC-to-DC converter, transformer, and/or another electrical converter or a part of such a converter, or a part thereof. In particular, the power electronics module is used to provide electricity to an electrical machine, e.g. an electric motor and/or a generator. A DC/AC inverter is preferably used to generate a multi-phase alternating current from a direct current generated by a DC voltage of a power source such as a battery. A DC-to-DC converter is used to convert (boost) a direct current from a fuel cell into a direct current that can be used by the HV internal electrical system 3 for the drive for example.

DC-to-DC converters and inverters for electric drives in vehicles, in particular passenger automobiles and utility vehicles, as well as buses, are configured for the high voltage range and configured in particular for a cut-off voltage class starting at ca. 650 volts.

### LIST OF REFERENCE SYMBOLS

105, 106 coupled chokes
10, 11 windings
Ru1-3 cores
Rtb1-4 connecting cores or core covers
30 air gap(s)
40 housing
41 gap filled with a thermally conductive material
50 potting material
C_1 input capacitor
C_S1, C_S2 symmetry capacitors
C_A1, C_A2 output capacitors
In−, In+ DC voltage inputs
Out−, Out+ DC voltage outputs

1. A symmetrical DC-to-DC boost converter, comprising:
at least two magnetically coupled chokes, wherein one choke is connected to a negative DC voltage input in the DC-to-DC boost converter, and wherein the other choke is connected to a positive DC voltage input in the DC-to-DC boost converter, such that a symmetrical topology is obtained with separate DC voltage inputs, wherein:
the at least two magnetically coupled chokes comprise three cores in a series, each of which is connected at a top and a bottom to a connecting core,
at least one winding on each of two outer cores of the three cores is dedicated to one of the chokes, and
a middle core of the three cores does not have a winding, and has at least one air gap and/or is at least partially made of a low permeability powdered material and therefore forms a magnetic energy storage.

2. The symmetrical DC-to-DC boost converter according to claim 1, wherein the air gap is formed by a single air gap.

3. The symmetrical DC-to-DC boost converter according to claim 1, wherein the air gap is formed by multiple air gaps.

4. The symmetrical DC-to-DC boost converter according to claim 1, wherein the middle core contains three air gaps.

5. The symmetrical DC-to-DC boost converter according to claim 1, wherein at least the two outer cores are made of a high permeability ferrite.

6. The symmetrical DC-to-DC boost converter according to claim 1, wherein the windings are formed by high frequency (HF) braids.

7. The symmetrical DC-to-DC boost converter according to claim 1, wherein the windings are formed by copper flat wire windings.

8. The symmetrical DC-to-DC boost converter according to claim 1, wherein the windings are formed by round copper windings.

9. The symmetrical DC-to-DC boost converter according to claim 1, comprising:
a cooling system configured to cool the at least two magnetically coupled chokes, wherein the cooling system contains a heat sink with a housing having at least one surface that corresponds to a shape of at least one of the at least two magnetically coupled chokes such that a gap is formed between a surface and the winding, which is filled with a thermally conductive material.

10. The symmetrical DC-to-DC boost converter according to claim 9, wherein the housing is filled with a thermally conductive potting material.

11. The symmetrical DC-to-DC boost converter according to claim 1, wherein the two outer cores have a minimal air gap.

12. A motor vehicle comprising:
the DC-to-DC boost converter according to claim 1; and
a fuel cell configured to power the motor vehicle.

13. A fuel cell drive for a motor vehicle, comprising:
a fuel cell; and
the DC-to-DC boost converter according to claim 1,
wherein the DC voltage inputs in the DC-to-DC boost converter are connected to the fuel cell and the DC voltage outputs are connected to a high voltage internal electrical system in the motor vehicle comprising an electric motor, as DC voltage inputs to the electric motor.

14. A motor vehicle comprising:
an electric motor powered by the fuel cell drive according to claim 13.
